(19) United States
(12) Patent Application Publication
(10) Pub. No.: US 2021/0278696 A1
(43) Pub. Date: Sep. 9, 2021

(54) Eyeglass frames with hooks for holding cigarettes and other objects

(71) Applicant: Alexander Stewart, San Diego, CA (US)

(72) Inventor: Alexander Blair Stewart, San Diego, CA (US)

(21) Appl. No.: 17/092,236

(22) Filed: Nov. 7, 2020

Related U.S. Application Data
(63) Continuation-in-part of application No. 17/006,324, filed on Aug. 28, 2020, now abandoned.
(60) Provisional application No. 62/893,303, filed on Aug. 29, 2019.

(51) Int. Cl. G02C 5/00; G02C 11/00

(52) U.S. Cl. CPC G02C 5/001; G02C 11/00

(57) ABSTRACT

Hooks are affixed to the temples or upper rims of eyeglass frames in parallel fashion with openings facing upright in order to hold a cigarette or other lightweight object. Hooks may be threaded into holes in eyeglass frames, affixed with adhesive, crimped onto the frame, or the hooks may be similarly affixed to a pair of small clamps to be removably clamped onto the sunglass frame. This invention allows the eyeglass wearer to store a cigarette, pencil, or other lightweight object(s) on the eyeglasses while they are being worn.

### CROSS-REFERENCE TO RELATED INVENTIONS

This application is based on the disclosure of Provisional Application No. 62/893,303 filed on Aug. 29, 2019.

### FIELD OF THE INVENTION

The present invention relates to the field of eyeglass frames, specifically the construction of temples with resilient, non-optical parts to be combined with diverse articles (US class D16/336, WIPO class G02C 5/16). Specifically, the present invention allows eyeglasses to be used to carry cigarettes and other lightweight objects.

### BACKGROUND OF THE INVENTION

Numerous devices have been patented to augment the temple portion of eyeglasses, but these are primarily ornamental (D771,740; D564,574; D655,744; D645,501; D635,608; D596,662; D501,866; U.S. Ser. No. 11/338,881) or designed to protect the eyeglasses (D655,743 S; D618,272 S; D593,146 S; D611,980; D389,853). There are also patents for devices that suspend a charm (D738,426; D792,500) from eyeglasses, removable clips attached to eyeglasses that hold flags (D833,517), and eyeglasses with interchangeable ornamentation (U.S. Pat. No. 8,545,011B2).

Clips affixed to eyeglasses have been patented (D480,414; D419,177; D312,773) that are suitable for clipping eyeglasses to clothing and other objects, such as a design for an eyeglass temple bar with a clip affixed to it (D616,487) and clips affixed to the temple of eyeglasses (U.S. Pat. Nos. 6,017,120; 6,343,859B1). But these are not designed to attach objects to the eyeglasses and store them on the eyeglasses while the eyeglasses are being worn.

None of the above designs removably hold functional, non-optical objects. Several patents cover eyeglass designs that integrate earphones or hearing aids (D548,767; D545,344; D260,774) or an MP3 player (D546,866; D545,344). Hooks for removably attaching a screen to an eyeglass lens (U.S. Pat. No. 6,007,197) have been patented, and a headlight that clips on to eyeglass frames has been patented (D405,901). However, no eyeglasses have been patented that are designed to carry small, lightweight objects—such as cigarettes—in a removable fashion while they are being worn. Therefore, techniques are needed to overcome the above mentioned disadvantages.

### SUMMARY OF THE DESCRIPTION

The invention is produced by affixing one or more pairs of hooks approximately 1.5-3 inches apart to the temples and/or the tops of the rims around the eyeglass lenses in order to hold one or more cigarette(s), pencil(s), pen(s), key(s) and other lightweight object(s). Hooks may be affixed by screwing them into or otherwise affixing them directly to the eyeglass frame, fabricating frames with hooks incorporated, or removably attached by affixing hooks to a pair of miniature clothespins, miniature alligator clips, or similar spring-loaded clamping devices each equipped with one or more hooks and clipped onto the temple portion of an eyeglass frame. The latter removable embodiment can also be removably attached to hat bands, brims, other accessories, and articles of clothing.

### BRIEF DESCRIPTION OF THE DRAWINGS

The present invention is illustrated by way of example and not limitation in the figures of the accompanying drawings in which like references indicate similar elements.

FIG. 1 illustrates how screw hooks are cut so that the threaded element of the hook is the same length as the width of the temple portion of the eyewear frame, according to one embodiment of the present invention. The figure also illustrates how holes are drilled in the eyeglass frame, according to one embodiment of the present invention.

FIG. 2 illustrates how the screw hooks are threaded into holes drilled in the eyewear frame to produce two parallel hooks with openings facing upright in order to hold a cylindrical object, according to one embodiment of the present invention.

FIG. 3 illustrates how a hand-rolled cigarette can be inserted into the hooks and stored according to one embodiment of the present invention.

FIG. 4 illustrates how the shoulder portion (encircled) of a screw hook is straightened in one embodiment of the present invention, to allow for multiple pairs of hooks to be inserted on the same temple of the eyewear frame, according to one embodiment of the present invention.

FIG. 5 illustrates how screw hooks modified in the fashion pictured in FIG. 4 are cut so that the threads are as long as the frame temples are wide, and holes are drilled for each hook in the distal portions of each temple and the tops of the rims, according to one embodiment of the present invention.

FIG. 6 illustrates how modified screw hooks are threaded into holes drilled in the distal portions of each temple so that one pair of hook faces upright and one pair faces downward on each temple. Two more pairs of hooks are threaded into the top of each rim until the threads are hidden and the hook openings are facing upright, according to one embodiment of the present invention that can hold six objects.

FIG. 7 illustrates how a total of six hand-rolled cigarettes can be inserted into pairs of hooks on the frame temples and over the rims, according to one embodiment of the present invention.

FIG. 8 illustrates how screw hooks modified as in FIG. 1 are threaded into holes in clamp assemblies, including but not limited to miniature wooden clothespins measuring approximately 1.25 inches in length, according to one embodiment of the present invention.

FIG. 9 illustrates how two clamp assemblies, including but not limited to miniature wooden clothespins, modified with screw hooks as in FIG. 8, are clamped to the temple of a pair of eyeglasses according to one embodiment of the present invention.

FIG. 10 illustrates how a hand-rolled cigarette can be inserted into the hooks affixed to two clamp assemblies when clamped to the temple of a pair of eyeglasses according to one embodiment of the present invention.

### DETAILED DESCRIPTION

Various preferred embodiments and aspects of the inventions will be described with reference to details discussed below, and the accompanying drawings will illustrate the various preferred embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

The invention consists of attaching at least two hooks approximately 1.5 and 3 inches apart to the temple portion of an eyeglass frame in order to insert and store one or more cigarettes; writing utensils; and other lightweight objects on the eyeglasses while being worn.

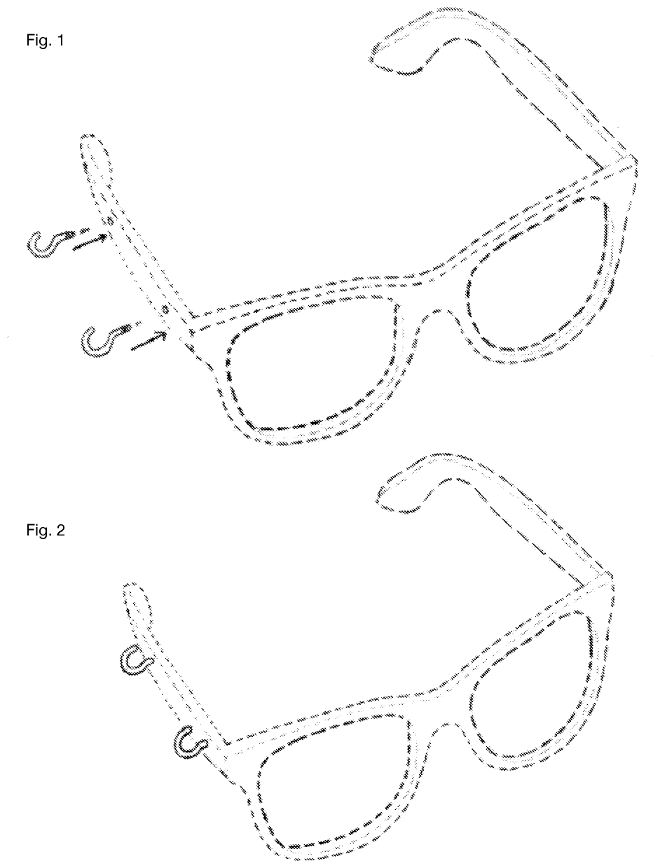

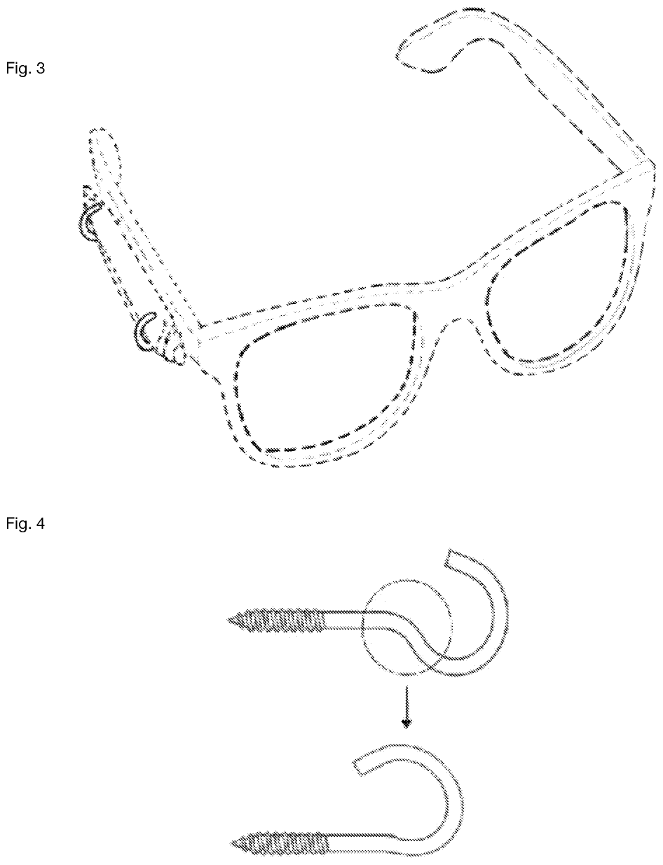

Construction of one embodiment of the invention (FIG. 1-3) begins with two ⅝ in. screw hooks and a pair of eyeglasses that has temples of at least 0.25 in. in height. Two holes are drilled into the center of the distal side of the temple approximately 1.5 in. to 3 in. apart as illustrated in FIG. 1. The threaded portion of the screw hook is cut until it is the same length as the width of the temple portion of the eyeglass frame (see FIG. 1). Then, each screw hook is threaded into the hole until the threads are hidden and the hook is facing upright when the eyewear is worn (FIG. 2). If the threaded portion of the hook extends through the eyeglass frame, it can be ground down with a rotary tool until flush. A cigarette, pencil, or lightweight, cylindrical object can then be inserted through both hooks and stored on the eyeglasses while worn as seen in FIG. 3. Other lightweight objects, such as keys or jewelry, can be hung from one or both hook(s).

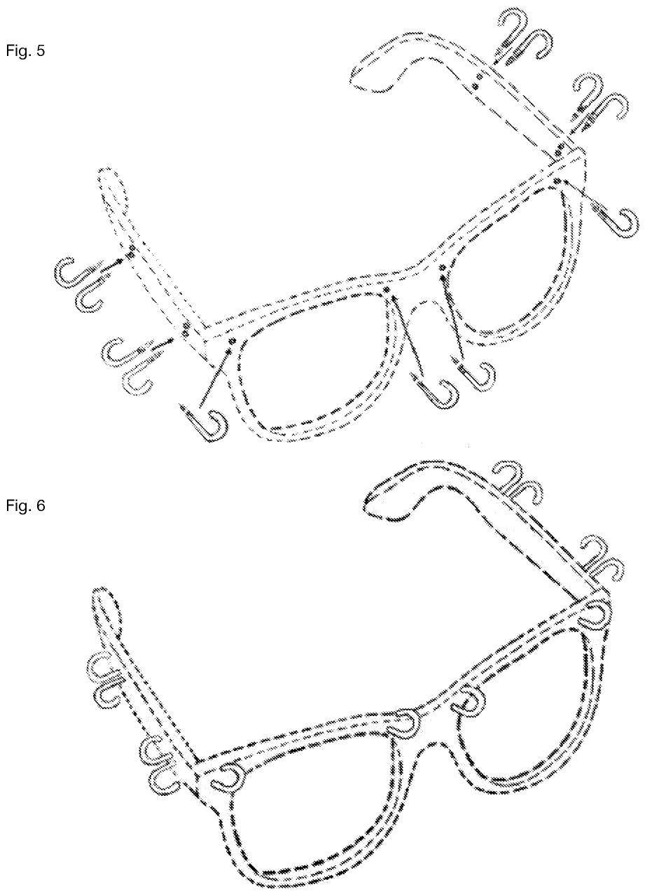

Construction of another embodiment of the invention (seen in FIG. 4-7) begins with twelve ⅝ in. screw hooks and a pair of eyeglasses that has temples of at least 0.25 in. in height. At least eight of these hooks must be bent at the shoulder, so that the neck of the hook will be perpendicular to the frame temples until it curves into the hook shape (see FIG. 4). All of the hooks may be bent in this manner for aesthetic reasons, or this step may be omitted in embodiments with eyeglass temples measuring approximately 0.75 inches in height or greater. The threaded portion of each screw hook is cut until it is the same length as the width of the temple portion of the eyeglass frame (see FIG. 5). In this embodiment four holes are drilled into the distal side of each temple located approximately equidistant from the top edge and the center line and equidistant from the bottom edge and the center line approximately 1.5 in. to 3 in. apart as illustrated in FIG. 5. Two holes are also drilled into the rim above each lens as well, approximately 1.5 in. to 3 in. apart. Then, each screw hook is threaded into a hole until the threads are hidden and the hook is facing upright when the eyewear is worn (FIG. 6). If the threaded portion of the hook extends through the eyeglass frame, it can be ground down with a rotary tool. Up to six cigarettes, pencils, or other lightweight objects then can be inserted through each pair of hooks in this embodiment of the present invention as seen in FIG. 7. Other lightweight objects, such as a key or piece of jewelry, can be hung from one or both hook(s).

Other embodiments include, but are not limited to, eyeglasses with two hooks on one temple and no additional hooks, two hooks on each temple without hooks over the rims around the lenses, three pairs of hooks on each temple with or without additional hooks over the rims, or hooks over the rims without hooks on the temples. Other embodiments employ eyelets or apparatus of diverse shapes that can function to removably hold cylindrical objects in a manner similar to hooks.

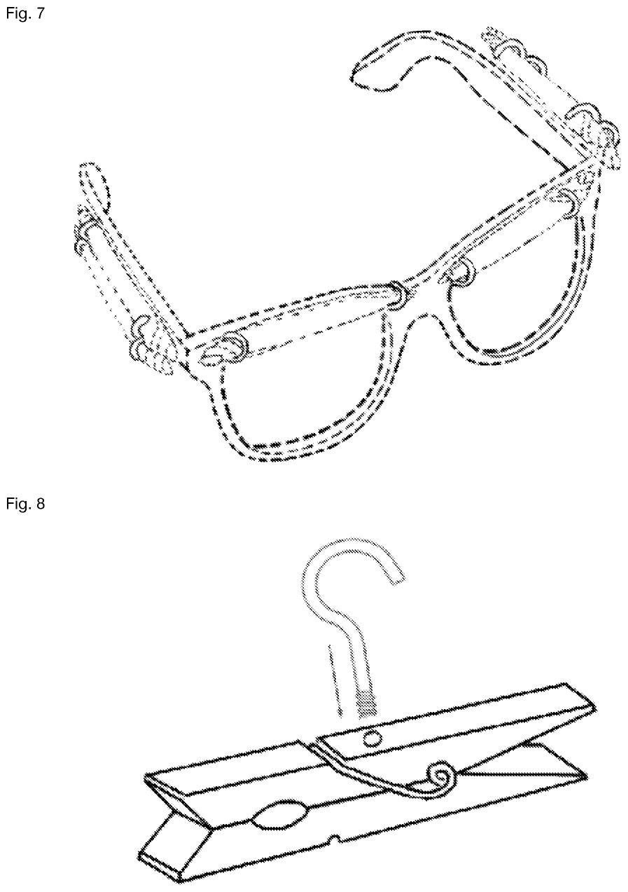

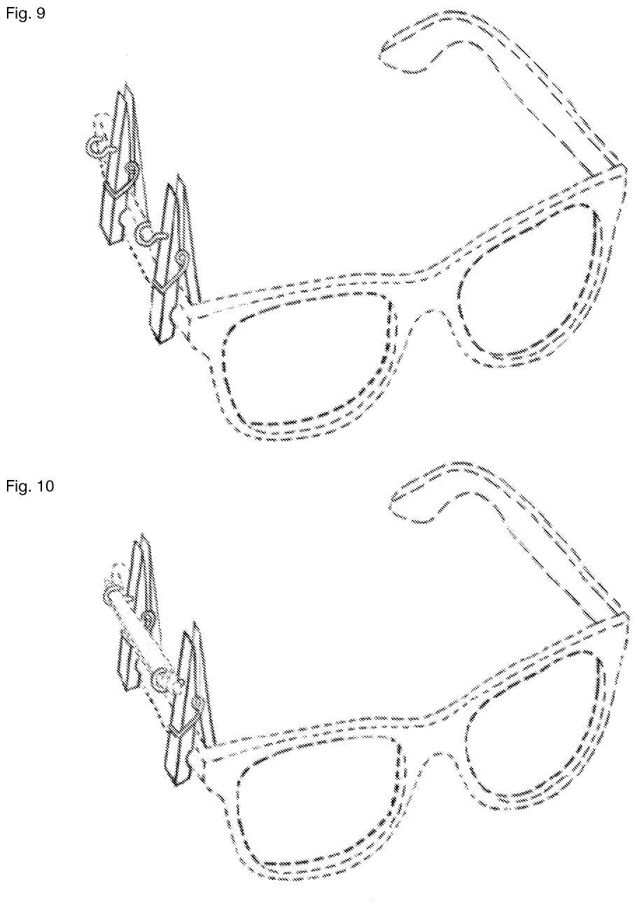

Construction of another embodiment (seen in FIG. 8-10) begins with two miniature clothespins, alligator clips, or similar self-contained clipping or clamping device measuring approximately 1.25 in. in length. ⅝ in. screw hooks, cut to an appropriate length as described above, are then screwed into miniature clothespins, soldered to miniature alligator clips, or otherwise affixed to or fabricated as part of similar small, lightweight clamping devices. Two of these miniature clothespins, miniature alligator clips, or similar devices can then be clipped onto eyeglass temples, hat brims, hat bands, other accessories, other articles of clothing, and other thin objects in order to hold a cigarette, pencil, or other lightweight object. Other lightweight objects, such as a key or piece of jewelry, can be hung from one hook, affixed as part of a pair or in isolation.

In another variation of this invention, hooks made of a flexible metal can be crimped onto eyeglass frame temples made of metal or other materials in a manner similar to that described above. The preferred embodiment features stainless steel hooks, but other variations can include hooks or eyelets of other materials. Another variation includes hooks with larger-sized openings to hold cigars or similar-sized objects. Another variation includes hooks with two different-sized openings in order to hold cone-shaped cigarettes or other conical objects of similar size.

The invention claimed is:

1. An improved frame for eyeglasses comprising a pair of hooks, eyelets, or similar apparatus attached in parallel alignment a short enough distance apart for said hooks to hold a cigarette, writing utensil, or other lightweight object when both hooks are used in conjunction:
(a) A frame as in claim 1 wherein a pair of hooks is attached to the temple portion of an eyeglasses frame;
(b) A frame as in claim 1 wherein a pair of hooks is attached above one or both lens(es);
(c) A frame as in claim 1 wherein multiple pairs of hooks is attached to one or both temples of the frame;
(d) A frame as in claim 1 wherein said hooks are constructed as part of the eyeglasses frame and formed of the same material;
(e) A frame as in claim 1 wherein said hooks are screwed into holes in the eyeglass frame;
(f) A frame as in claim 1 wherein said hooks are attached with solder or adhesive;
(g) A frame as in claim 1 wherein said hooks of claim 1 wherein said hooks are attached by crimping.

2. A clamp assembly for removably improving eyeglass frames and other accessories as in claim 1 comprising
a clamp including two levers linked at the middle areas thereof with first ends working together to form clamping jaws and second, opposite, ends thereof formed as opening grips for separating clamping jaws, said clamp also including a spring means for loading the clamping jaws toward one another,
one or more hooks, eyelets or similar apparatus attached to one of the levers of said clamp that can function as in claim 1 to hold cigarette(s), writing utensil(s), or other lightweight object(s) when the two clamp assemblies in the pair are attached and used in conjunction:
(a) A clamp assembly as in claim 2 wherein said clamp is made of metallic material;
(b) A clamp assembly as in claim 2 wherein said clamp is are made of wood;
(c) A clamp assembly as in claim 2 wherein said clamp is made of plastic or similar synthetic material;
(d) A clamp assembly as in claim 2 wherein said hook is constructed as part of the clamp and formed of the same material;
(e) A clamp assembly as in claim 2 wherein said hook(s) are screwed into holes in the clamps;
(f) A clamp assembly as in claim 2 wherein said hook(s) are attached to said clamps with solder or adhesive;
(g) A clamp assembly as in claim 2 wherein said hook(s) are attached to said clamps by crimping.
